(19) United States
(12) Patent Application Publication
(10) Pub. No.: US 2025/0224808 A1
(43) Pub. Date: Jul. 10, 2025

(54) GESTURE-CONTROLLED SYSTEMS AND METHODS

(71) Applicant: Lattice Semiconductor Corporation, Hillsboro, OR (US)

(72) Inventors: Jacob Fiset, Montreal (CA); Martin Gamsby, Charlemagne (CA); Michel Boivin, Brossard (CA)

(21) Appl. No.: 19/008,465

(22) Filed: Jan. 2, 2025

Related U.S. Application Data
(60) Provisional application No. 63/618,816, filed on Jan. 8, 2024.

(51) Int. Cl. G06F 3/01; G06V 10/82; G06V 40/10; G06V 40/20

(52) U.S. Cl. CPC G06F 3/017; G06V 10/82; G06V 40/10; G06V 40/28

(57) ABSTRACT

Gestured-controlled systems and methods are disclosed. The system may include one or more imaging devices, such as two-dimensional (2D) or infrared (IR) cameras configured to capture one or more images of a scene with a user. The system may detect a gesture depicted by a hand of the user in the image to determine an associated user command. In one or more embodiments, such gestures may be used to control various components, devices, or systems.

### CROSS-REFERENCE TO RELATED APPLICATIONS

This application claims priority to and the benefit of U.S. Provisional Patent Application No. 63/618,816 filed Jan. 8, 2024, and entitled “GESTURE-CONTROLLED SYSTEMS AND METHODS,” which is incorporated herein by reference in its entirety.

### TECHNICAL FIELD

The present disclosure relates generally to remote operation of a system and, more particularly, to gesture-controlled systems and methods.

### BACKGROUND

Remotes are commonly used devices for remotely operating electronic devices, such as entertainment systems that may include televisions, gaming systems, media players, sounds systems, and the like. However, remotes may be easily lost, can lack intuitive operation, require separate powers sources, and often malfunction. Furthermore, often each device or system of an entertainment system may require a corresponding remote, which can lead to clutter in an area. These factors can significantly limit the operational flexibility and ease of use of such systems. Thus, there is a need for systems and methods to provide user-friendly alternatives to the remote operation of electronic devices.

### SUMMARY

In one or more embodiments, a method includes receiving an image of a scene. The method further includes detecting a face and a hand of a user in the image. The method further includes assigning first and second points to the face and the hand, respectively, in a three-dimensional space. The method further includes calculating a vector extending from the first point through the second point to a terminal point on a plane in the three-dimensional space. The method further includes updating a portion of a user interface associated with the terminal point.

In one or more embodiments, a system includes an imaging device configured to provide an image of a scene. The system also includes a logic device configured to receive the image, detect a face and a hand of a user in the image, assign first and second points to the face and hand, respectively, in a three dimensional space, calculate a vector extending from the first point through the second point to a terminal point on a plane in the three dimensional space, and update a portion of a user interface associated with the terminal point.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE FIGURES

FIG. 1A illustrates a block diagram of a gesture-controlled system in accordance with an embodiment of the disclosure.

FIG. 1B illustrates a schematic diagram of an artificial neural network in accordance with an embodiment of the disclosure.

FIG. 2 illustrates a flow chart of a process for interacting with a gesture-controlled system in accordance with an embodiment of the disclosure.

FIGS. 3A-3E illustrate operation of a gesture-controlled system in accordance with embodiments of the disclosure.

FIG. 4 illustrates a flow chart of a process for operating a gesture-controlled system in accordance with an embodiment of the disclosure.

FIG. 5 illustrates a flow chart of a process for assigning identifiers using a gesture-controlled system in accordance with an embodiment of the disclosure.

FIG. 6 illustrates a flow chart of a process for determining a hand depth estimation using a gesture-controlled system in accordance with an embodiment of the disclosure.

FIG. 7 illustrates a flow chart of a process for determining overlap using a gesture-controlled system in accordance with an embodiment of the disclosure.

FIG. 8 illustrates a flow chart of a process for checking criteria using a gesture-controlled system in accordance with an embodiment of the disclosure.

FIG. 9 illustrates landmarks assigned to a hand of a user in accordance with an embodiment of the disclosure.

FIGS. 10A-10E illustrate various hand depth estimates in accordance with embodiments of the disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for gesture-based operations. More specifically, provided herein is a gesture-controlled system that may replace remotes (e.g., handheld physical remote control devices such as dedicated hardware devices and/or software running on other handheld devices such as smartphones), offering a simpler and more intuitive way of controlling various electronic systems and devices, such as an entertainment system. In various aspects, the system may provide rapid remote control of electronic systems using gestures and may include a separate system or be implemented with one or more existing interfaces. For example, systems and methods provided herein may be implemented in the use of an entertainment system (e.g., a television, gaming system, sound system, or other appropriate device).

In one or more embodiments, the system may include one or more imaging devices (e.g., two-dimensional (2D) or infrared (IR) cameras) configured to capture one or more images (e.g., pictures and/or videos) of a scene. The 2D camera may include a 2D red-green-blue (RGB) camera and may be an on or off-the-self camera, which allows for management of affordability of the system. The user's hands and face may be identified and tracked within a scene captured by the imaging device, and a logic device of the system may be configured to determine a three-dimensional (3D) position of points (e.g., landmarks, markers, or anchors) of the face and one or more hands (e.g., palm, wrist, and/or fingers) of the user. Using the determined 3D positions of the face and hand within the scene, the system may project a vector intersecting a plane (e.g., such as a plane defined by a display of the television) based on the position of the face and/or hands. A portion of a user interface associated with a terminal point of the vector that intersects the plane may then be updated in response.

In one or more embodiments, the system may detect a gesture depicted by the hand in the image to determine an associated user command. For instance, by comparing the position of hand landmarks relative to each other, a gesture can be determined, where the gesture is associated with a command that instructs the system to update the user interface (e.g., perform actions, such as on-screen actions, at or proximal to the terminal point on the display). Tracking multiple factors (e.g., hand position, finger position, head position, head orientation, facial aspects or expressions, and the like) creates a robust and efficient system, allowing the system to more easily detect subtle gestures and removing the possibility of false positives. Additionally, the system uses tracking processes that are efficient and require low computing power. Thus, the system may be used with various devices and systems, such as laptops, desktops, tablets, power plugs, televisions, displays, lightbulbs, thermostats, cameras, cellphones, and the like. In various embodiments, the system may emulate already familiar input modalities (e.g., peripheral devices such as a mouse, keyboard, touchscreen, and so on) for ease of use.

In some aspects, gestures may be used to control various components, devices, or systems. For instance, gestures may be used to control a sound system and a display of an entertainment system that are made by different manufacturers.

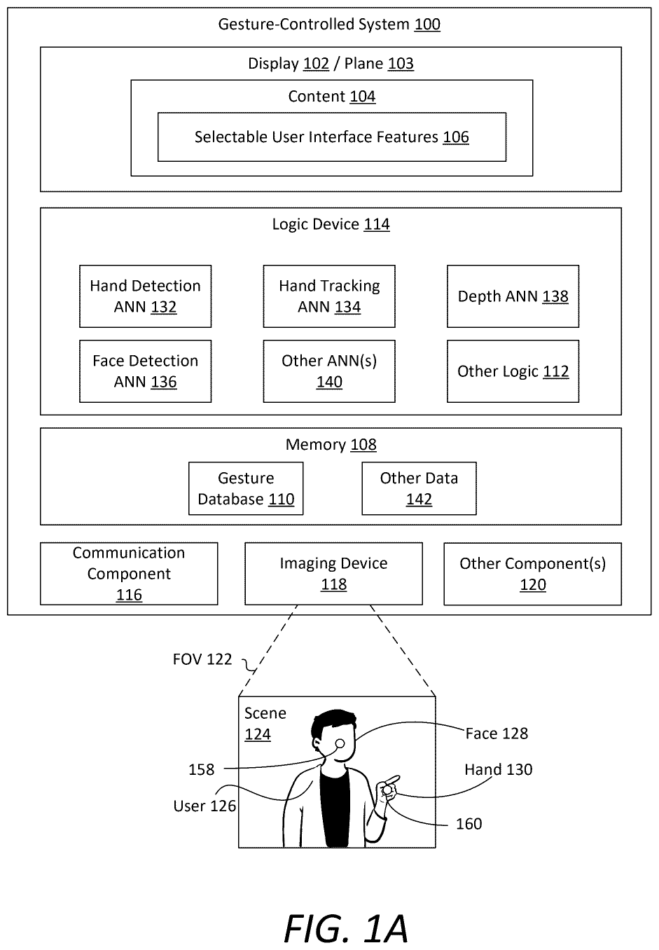

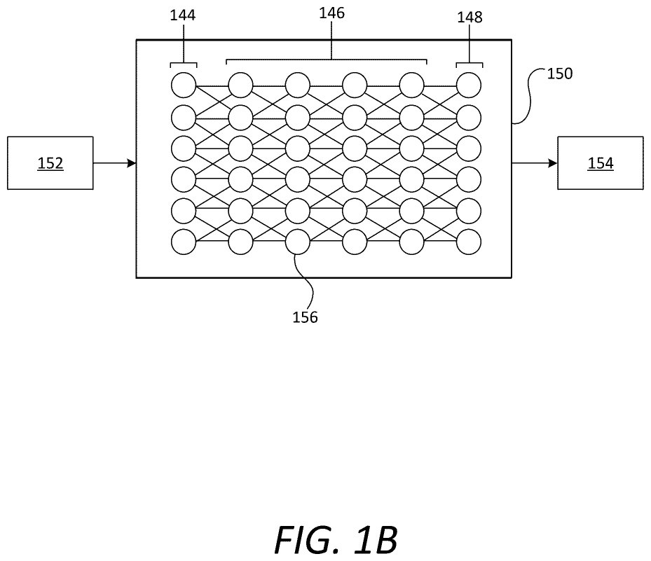

Referring now to the drawings, wherein the showings are for purposes of illustrating embodiments of the present disclosure and not for purposes of limiting the same, FIG. 1A shows a block diagram of a gesture-controlled system in accordance with an embodiment of this disclosure. Gesture-controlled system 100 (also referred to herein as a “system”) may include various components, such as, but not limited to, a display 102, a logic device 114, a memory 108, a communication component 116, an imaging device 118, and/or other components 120.

In some embodiments, logic device 114 may be implemented as any appropriate logic device, such as, for example, a computing device, a controller, single-core processor, multi-core processor, control circuit, processor, microprocessor, programmable logic device (PLD) configured to perform processing operations, processing device, digital signal processing (DSP) device, system on a chip (SOC), application specific integrated circuit (ASIC), field programmable gate array (FPGA), memory storage device, memory reader, and/or any other appropriate combinations of processing devices and/or memory to execute instructions to perform appropriate operations, such as, for example, software instructions implementing a control loop for controlling various operations of system 100. Such software instructions may also implement methods for processing images, processing sensor signals, determining sensor information, providing user feedback (e.g., through user interface), querying devices for operational parameters, selecting operational parameters for devices, or performing any of the various operations described herein (e.g., operations performed by logic devices of various devices of system 100).

Logic device 114 may include, be included in, and/or communicate with any component of gesture-controlled system. In some embodiments, logic device 114 may include a single logic device operating independently. In other embodiments, logic device 114 may include two or more logic devices operating in parallel, in concert, or sequentially. In various embodiments, logic device 114 may include a plurality of logic devices in a single integrated unit. In other embodiments, logic device 114 may include a plurality of logic devices part of two or more computing devices or systems. For instance, logic device 114 may include a singular logic device or a cluster of logic devices in a first location, and a second logic device or cluster of logic devices in a second location. In various embodiments, logic device 114 may be implemented as a memory, wherein logic device may include one or more logic devices dedicated to data storage. In various embodiments, logic device 114 may distribute tasks and/or processes, as described herein, across a plurality of logic devices, where the plurality of logic devices may operate in parallel, in series, redundantly, or in any other manner appropriate for operating system 100. In one or more embodiments, logic device 114 may be configured to perform any process, step, and/or sequence of steps described herein in any order and with any degree of repetition.

Logic device 116 may be communicatively connected to any components described in this disclosure and configured to interface and/or communicate with the various components of system 100. In various embodiments, it should be appreciated that processing operations and/or instructions may be integrated in software and/or hardware as part of logic device 114, or code (e.g., software or configuration data) which may be stored in a memory device, such as memory 108. Embodiments of processing operations and/or instructions disclosed in this disclosure may be stored by a machine-readable medium in a non-transitory manner (e.g., a memory, a hard drive, a compact disk, a digital video disk, or a flash memory) to be executed by a computing device (e.g., logic or processor-based system) to perform various operations. In one or more embodiments, logic device 114 may include a processor configured to execute instructions stored in a first memory and/or a programmable logic device (PLD) operable in accordance with a configuration of programmable logic blocks stored in a second memory.

In some embodiments, logic device 114 may be configured to receive images from imaging device 118 (e.g., an imaging module), process the images, store the original and/or processed images in memory 108, and/or retrieve stored images from memory 108. In various aspects, logic device 114 may be configured to receive images from imaging device 118 through wired and/or wireless communication using, for example, communication component 116. In one or more embodiments, logic device 114 may be configured to process images. For instance, logic device 114 may use machine-learning modules and/or neural networks to process one or more images provided by imaging device 118. For example, logic device 114 may use artificial neural networks (ANNs), such as hand detection ANN 132, hand tracking ANN 134, face detection ANN 136, depth ANN 138, other ANNs, as described further herein below. In various embodiments, logic device 114 may also include other logic 112.

In some embodiments, memory 108 may store software instructions and/or databases used by logic device 114. For instance, memory 108 may include a machine-readable medium that may be provided for storing non-transitory instructions for loading into and execution by logic device 114. In various embodiments, memory 108 may be included as part of logic device 114 and/or separate from logic device 114, with stored instructions provided to logic device 114 by communicatively connecting memory 108 to logic device 114. In various embodiments, as described herein, instructions provide for real time applications of processing various images of scene 124. In an aspect, a scene may be referred to as an object, a target scene, or a target object.

In some embodiments, memory 118 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, or other types of memory. In some embodiments, memory 108 may include RAM (e.g., static and/or dynamic) memory and/or flash memory, clock-related circuitry (e.g., clock sources, phase-locked loop (PLL) circuits, and/or delay-locked loop (DLL) circuits), and/or various routing resources (e.g., interconnect and appropriate switching logic to provide paths for routing signals throughout logic device 114, such as for clock signals, data signals, or others) as appropriate.

As previously mentioned, logic device 114 may be configured to execute software stored in memory 108 to perform various methods, processes, and/or operations in a manner as described herein. In various embodiments, memory 108 may be implemented as a volatile memory, non-volatile memory, one or more interfaces, and/or various analog and/or digital components for interfacing with devices and/or components of system 100. For example, memory 108 may be adapted to store images (e.g., image data or sensor information), parameters for image transformations, operation parameters, calibration parameters, and/or other operational parameters. In some embodiments, memory 108 may be adapted to execute one or more feedback loops for operation of system 100. In some embodiments, a feedback loop may include processing images, sensor signals, and/or parameters in order to control one or more operations of system 100.

In various embodiments, memory 108 may be adapted to store databases, such as a gesture database 110 or other data 142. Other data 142 may include any data or information (e.g., instructions) used by system 100, such as logic device 114, to perform any processes, steps, and/or sequences of steps described herein. For instance, in some embodiments, other data 142 may include training data (e.g., training data sets) used for generating and/or training ANNs 132, 134, 136, 138, and 140. In some embodiments, other data 142 may include a face database providing facial attributes and/or associated identifiers related to a user of system 100. For example, face database may include data associated with facial attributes (e.g., features) of a first user, so that logic device 114 may identify and assign an identifier (e.g., identification or tag) to user 126 and/or one or more other users in scene 124. Face database may include historical facial data so that facial features of one or more past users may be stored on and recalled from memory 108. In various embodiments, face database may include various types of expressions and/or orientations (e.g., angles or positions of a user face). The various types of expression may be used by logic device 114, such as ANNs, to assist in determining a command and preventing a false positive. For example, if a user is looking away from imaging module 118 and/or plane 103 while making an initiation gesture, logic device 114 may not initiate system 100 considering by considering the gesture unintentional.

In one or more embodiments, gesture database 110 may include one or more gestures (e.g., one or more positions and/or orientations of a hand) that each may be associated with a user command (also referred to herein as a “command”). For example, a gesture including a fist may be associated with a command to initiate a session of system 100, as discussed further herein below. In another example, a gesture including a pinching motion may be associated with a command to select a selectable feature 106 of content 104. Gesture database 110 may be generated, updated, and/or altered by a manufacturer and/or by a user (e.g., by user input).

As non-limiting examples, gestures of gesture database 110 may include, but is not limited to, the following: an index position relative to a knuckle of hand 130 for a click (e.g., selection gesture), where determining a position of other fingers relative to the knuckle prevents false positives; swiping hand 130 across scene 124 for a scrolling command, a finger up gesture for an initiation gesture, a hand wave for an end gesture, a finger waving for a scrolling command, a hand gesture to go back within a user interface (e.g., a menu of the display), and so on. In one or more embodiments, hand orientation may also be taken into consideration to prevent false positives by logic device 114.

In various embodiments, gesture database 110 may include a sequence of gestures that provide a command. A sequence of gestures may include a plurality of gestures performed in a specific order within a predetermined amount of time. For example, a sequence of gestures may include a first gesture of outstretching a thumb and pointer finger and a subsequent second gesture of touching the pointer finger and the thumb together. Such gestures being performed in combination may, for example, provide a selection command (e.g., instructions) for system 100 to select a selectable feature, which may update user interface, as discussed further herein.

In various embodiments, detected gestures of hand 130 may be compared to gestures from gesture database 110. In other embodiments, gesture database 110 may include training data (e.g., training data set) used by one or more ANNs of logic device 114 to process images from imaging device 118. For instance, gesture database 100 may include gesture training data.

In one or more embodiments, training data may include inputs and outputs from databases (e.g., gesture database, face database, and the like), resources, and/or manual user inputs (e.g., data entered by a user) used for generating a machine-learning model and/or neural network. For example, training data may include training inputs and correlated training outputs that may be received by logic device 114 to generate and/or train a neural network, such as the ANNs described in FIG. 1A. In several embodiments, correlations may indicate causative or predictive links between data (e.g., inputs and outputs) and may include modeled relationships (e.g., mathematical relationships). For example, a neural network, such as depth ANN 138, may use correlations to determine an output, such as a command, from an input, such as a detected gesture. In some embodiments, training data may include historical training data, where historical training data includes previously received inputs and corresponding determined outputs. In some embodiments, neural network may iteratively be updated using previously used inputs and determined outputs.

In some embodiments, training data may be organized into categories using a classifier that associates the training data with one or more descriptors of corresponding categories. For instance, the classifier may be used to sort inputs into categories or bins of data and may output the categories or bins of data and/or labels associated therewith. In various embodiments, the classifier may be configured to output data that is labeled or identified a particular set of data clustered together. In some embodiments, logic device 114 may be configured to generate the classifier using training data.

In one or more embodiments, system 100 includes imaging device 118, which is configured to capture one or more images (e.g., frames) of a scene 124 that is within a field of view (FOV) 122 of imaging device 118. In several embodiments, user 126 may be within scene 124. In one or more embodiments, faces 128 and/or one or more hands 130 of one or more users 126 may be detected by logic device 114, as described further in herein below. In various embodiments, a first point 158 may be associated with face 128, and a second point 130 may be associated with hand 130.

In one or more embodiments, imaging device 118 may be used to capture images of scene 124, such as visible and/or non-visible light images. For instance, and without limitation, imaging device 118 may be used to capture and process two-dimensional (2D) visible light images (e.g., RGB frames). In another instance, and without limitation, imaging device 118 may be used to capture and process infrared (IR) images (e.g., thermal frames). In one or more embodiments, a position of imaging device 118, as well as other system parameters (e.g., a size of display 102, a location of imaging device 118 relative to display 102, imaging capabilities of imaging device 118, and so on), may be provided during user calibration and/or factory calibration. In one or more embodiments, system parameters may be for assigning points, calculating vectors, and so on, as described further herein below.

In one or more embodiments, imaging device 118 may include one or more imaging devices. For instance, imaging device 118 may include a plurality of imaging devices positioned at various locations, where each imaging device may provide a different perspective of scene 124. Various perspectives of the same scene may allow for continuous tracking despite obstructions (e.g., occlusions). For instance, a user's face may be obstructed by an object in a first image having a first perspective of scene 124 from a first imaging device, but the user's face is not obstructed by the object in a second image having a second perspective of scene 124 from a second imaging device, allowing system 100 to continuously track the user's face during operation of system 100. In other embodiments, imaging devices may be positioned at a relatively same position to provide, for example, redundancy. For example, if one imaging device malfunctions, the other imaging device may provide one or more images to allow system 100 to continue operating properly.

In one or more embodiments, imaging device 118 may include one or more visible light imaging devices, infrared imaging devices, ultraviolet imaging devices, any combination thereof, and the like. For instance, imaging device 118 may include a two-dimensional (2D) camera, a three-dimensional (3D) camera, a four-dimensional (4D) scanner (e.g., a laser scanner configured to digitally capture the shape of an object and/or user, creating point clouds of data), an infrared (IR) camera, an ultraviolet light camera, and so on. Imaging device 118 is configured to capture one or more images (e.g., image data) of user 126 and scene 124.

In various embodiments, imaging device 118 may include a focal plane array (FPA) or some other type of imaging device. Imaging device 118 may also include analog-to-digital converters to digitize an image captured by imaging device 118. The image may be stored in memory 108. In one or more embodiments, suitable image processing may be performed by logic device 114, which can be a software or firmware programmed computer processor or a hardwired processor. As previously mentioned herein, logic device 114 may represent any number of logic devices working in concert or independently. In some embodiments, one or more of such logic devices, possibly all of them, can be provided externally, outside of imaging device 118, possibly remotely, and can communicate with imaging device 118 over a computer network, such as the Internet, using communication component 116. Communication component 116 may provide wired and/or wireless connection to circuits, components, and/or devices inside and outside of system 100. In some embodiments, all the controllers (e.g., logic devices) may be within imaging device 118. In some embodiments, communication component 116 is absent. For example, in some embodiments, memory 108 is a plug-in module, and such modules can be unplugged and plugged into other systems (e.g., other computing devices) to read image data out of memory 108, and to write memory 108 with programs and/or data used by imaging device 118. Memory 118 may then be plugged back into imaging device 118, and memory parameters can be read by logic device 114.

In non-limiting embodiments, system 100 may be implemented for use with navigating a user interface (UI) remotely. For instance, system 100 may be used to navigate content 104. In some embodiments, content 104 may be shown on a display 102 (e.g., television screen, monitor, or other display device). For example, user 126 may perform a command by pointing at display 102 to update the user interface, as discussed further herein below.

In some embodiments, system 100 may include display 102, which is communicatively connected to logic device 114, and/or any other components of system 100, and configured to show content 104 and provide visual user feedback related to updates of the user interface. Display 102 may include an image display component or device (e.g., a liquid crystal display (LCD), head-up display, projection, light emitting diode (LED), LED screen, cathode ray tube (CRT), touchscreen) or various other types of generally known video displays or monitors. Logic device 114 may be configured to transmit and display content 104 using display 102. In one or more embodiments, content 104 may include any information provided to a user. For instance, content 104 may include information displayed to the user using display 102. In another instance, content 104 may include information or data associated with a particular subject or feature. For example, if system 100 includes a thermostat, content 104 may include information related to ambient temperature, a heating system status, a cooling system status, and so on. In another example, if system 100 includes a smart plug, content 104 may include information related to voltage, current, location, power actuations, identification, communication control, and so on. In another example, if system 100 includes an entertainment system, then content may include information related to movies, games, episodes, volume, music, and so on. In one or more embodiments, content 101 may include menus, digital signage, and so on that may or may not be shown on a display of system 100. If content is shown on display 102, then content 104 may also include the manner in which the information is displayed (e.g., associated visual representations).

In one or more embodiments, content 104 may include selectable user interface features 106. Selectable user interface features 106 (also referred to herein as “selectable features” or “features”) may include navigable features of content 104. In some embodiments, display 102 may include a user interface, such as a graphical user interface (GUI), showing one or more selectable features 106 implemented as user-activatable features. For instance, selectable feature 106 may include icons, symbols, text, images, regions, and so on, that may be interacted with (e.g., selected) to navigate through content of the user interface. For example, in a non-limiting exemplary embodiment, selectable feature may include a thumbnail of a movie title that the user may select, using logic device 114, in order to navigate to a new menu providing additional information related to the movie.

Logic device 114 may be configured to retrieve content 104 and information from memory 108, a server, and/or a remote device (e.g., such as a provider device) and display any retrieved information on display 102. Display 102 may include display devices, which may be used by logic device 114 to display information, such as content 104 and selectable features 106. In some embodiments, display 102 and logic device 114 may represent appropriate portions of a television, tablet, laptop computer, desktop computer, thermostat, entertainment system, projection system, gaming system, interactive system, and the like. Display 102 may receive information directly or indirectly using communication component 116, as discussed further herein below.

In some embodiments, communication component 116 may be implemented as a connector (e.g., to interface one or more electronic components to an external device), a network interface component (NIC) configured for communication with a network including other devices in the network, and/or other implementations. In various embodiments, communication component 116 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components configured for communication with a network, a LAN card, a modem, and any combination thereof. As such, communication component 116 may include an antenna coupled thereto for wireless communication purposes. In other embodiments, the communication component may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

Communication component 116 may be implemented as any wired and/or wireless communications module and/or device configured to transmit and receive analog and/or digital signals between components of system 100 and/or remote devices and/or systems. For example, communications module 116 may be configured to receive control signals and/or data and provide them to logic device 114 and/or memory 108. In other embodiments, communication component 116 may be configured to receive images and/or other sensor information from imaging device 118, logic device 114, and the like and relay the corresponding data within system 100 and/or to external systems. Wireless communication links may include one or more analog and/or digital radio communication links, such as Wi-Fi and others, as described herein, and may be direct communication links, for example, or may be relayed through one or more wireless relay stations configured to receive and retransmit wireless communications. Communication links established by communication component 116 may be configured to transmit data between components of system 100 substantially continuously throughout operation of system 100, where such data includes various types of image data (e.g., images), sensor data, control parameters, and/or other data, as described herein.

In one or more embodiments, logic device 114 may interface or communicate with one or more additional devices and/or systems using communication component 116. Communication component 116 may be configured to communicative connect logic device 114 to one or more networks and/or one or more devices. Examples of a network interface device include, but are not limited to, a network interface card (e.g., A network may employ a wired and/or a wireless mode of communication. In general, any network topology may be used. Information (e.g., data, software etc.) may be communicated to and/or from a computer and/or a computing device. Examples of a network may include, but are not limited to, a local area network (LAN), wide area network (WAN), telephone network, data network, a direct connection between two computing devices (e.g., logic device 116 and another device and/or system), or any combinations thereof.

In some embodiments, a network may be implemented as a single network or a combination of multiple networks. For example, in various embodiments, the network may include the internet and/or one or more intranets, landline networks, wireless networks, and/or other appropriate types of communication networks. In another example, the network may include a wireless telecommunications network (e.g., cellular phone network) configured to communicate with other communication networks, such as the internet. As such, in various embodiments, imaging device 100 and/or its individual associated components may be associated with a particular network link such as for example a URL (Uniform Resource Locator), an IP (Internet Protocol) address, and/or a mobile phone number.

In some embodiments, system 100 may include other components 120. For instance, in some non-limiting exemplary embodiments, other components 120 may include one or more sensors. In some embodiments, the one or more sensors may include an array of sensors (e.g., any type of visible light, infrared, ultraviolet, or other type of detector) for capturing images of scene 124. In various embodiments, sensors may provide for representing (e.g., converting) captured images of scene 124 as digital data (e.g., via an analog-to-digital converter included as part of the sensor or separate from the sensor as part of system 100). In various embodiments, other components 120 may include an imager interface that may provide the captured images to logic device 114 which may be used to process the image (e.g., frames), store the original and/or processed image in memory 108, and/or retrieve stored images from memory 108, as previously discussed in this disclosure. In some embodiments, other components 120 may include a power source.

In some embodiments, sensors may include one or more other types of sensing components, including environmental and/or operational sensors, depending on the sensed application or implementation, which provide information to logic device 114 (e.g., by receiving sensor information from each sensing component). In various embodiments, other sensing components may be configured to provide data and information related to environmental conditions (e.g., thermistors, thermometers, humidity sensors, moisture sensors, pressure sensors, Hall effect sensors, and so on), lighting conditions (e.g., light sensor), distance (e.g., laser rangefinder, light detection and ranging (LIDAR), scanners, and the like), rotation (e.g., a gyroscope), movement (e.g., accelerometer), electrical sensors (e.g., voltmeters, current sensors, power sensors, and the like), and so on. In some embodiments, other sensing components may include one or more conventional sensors as would be known by those skilled in the art for monitoring various conditions that may have an effect (e.g., on the image appearance) on the data provided by imaging device 118.

Conventional tracking systems often require advance logic and user experience (UX) development and are not readily available for use in commercial products. Furthermore, tracking systems often have difficulty operating under various common conditions. For example, tracking systems may struggle with low-light environments, complex backgrounds in scenes or FOVs (e.g., noise), occlusions (e.g., obstructions), certain camera distances, certain poses, and so on. In some embodiments, one or more ANNs may be used to overcome such issues, as described further in this disclosure.

Now referring to FIG. 1B, a block diagram of an exemplary embodiment of an ANN 150 is illustrated in accordance with an embodiment of the disclosure. In various embodiments, ANN 150 may be used to implement any ANNs discussed in this disclosure, such as hand detection ANN 132, hand tracking ANN 134, face detection ANN 136, depth ANN 138, other ANNs 140, and the like. ANN 150 may receive data inputs 152 (e.g., image from imaging device 118) and provide inferences 154 (e.g., outputs) in response thereto. For example, as discussed further herein below, successive video frames (e.g., video frame f0 followed by video frame f1, and so on) may be provided and processed by ANN 150.

As shown, ANN 150 includes various nodes 156 arranged in multiple layers including an input layer 144, hidden layers 146, and an output layer 148. In some embodiments, the full number of data inputs 152 may be processed through all of layers 144, 146, and 148 before inference 154 is provided. Although particular numbers of hidden layers 146 are shown, any desired number of hidden layers may be provided in various embodiments. Also, although particular numbers of nodes 156 are shown in layers 144, 146, and 148, any desired number of nodes 204 may be provided in various embodiments.

In some embodiments, ANN 150 may be implemented to run in parallel with other ANNs on separate hardware devices that differ in complexity and/or processing capability to accommodate the different processing features of each ANN used. For example, in some embodiments, ANN 150 may be implemented in a high-performance logic device (e.g., a GPU or other processor), while a second ANN, such as a low latency ANN, may be implemented in a low power logic device (e.g., a PLD). In other embodiments, ANN 150 and other ANNs 140 may be implemented to run on the same logic device sequentially (e.g., using a single processing core) or in parallel (e.g., using multiple processing cores).

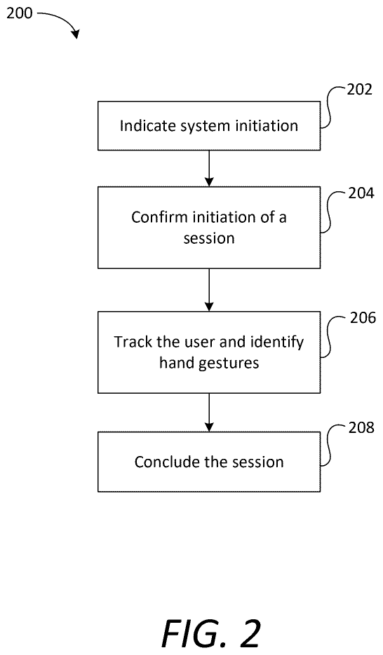

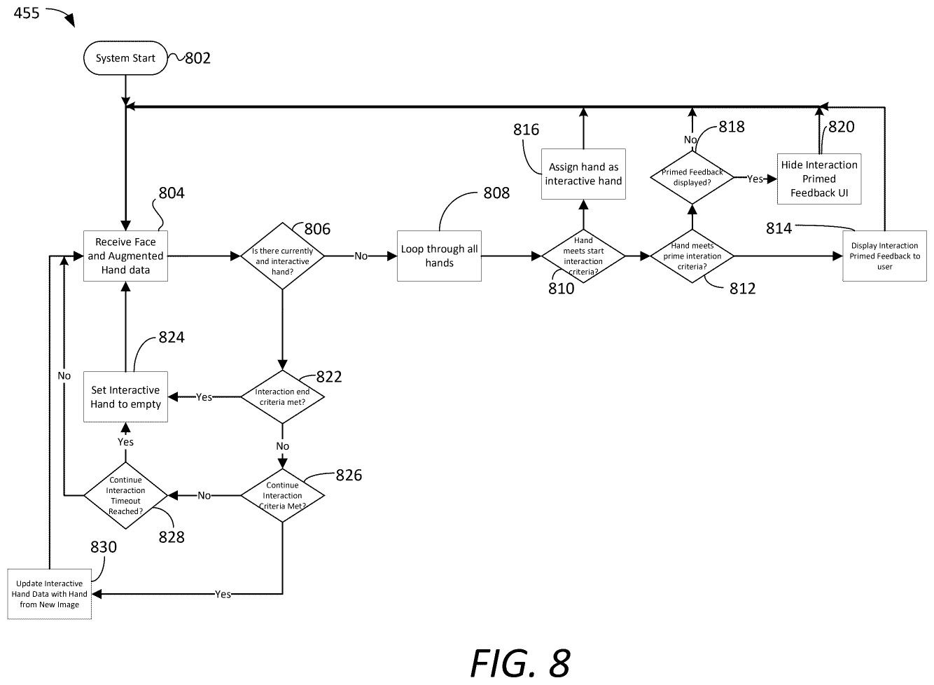

Now referring to FIG. 2, a process 200 for interacting with gesture-controlled system 100 in accordance with an embodiment of this disclosure. As previously mentioned in FIG. 1A, system 100 may be configured to detect a gesture depicted by hand 130 of user 126 in the image. Process 200 may include a process for checking criteria for operational states using system 100, which is also discussed further in FIG. 8 herein below.

In some embodiments, the various steps of FIG. 2 identify operational states of system 100 associated with detection of different gestures made by user 126 using their hand 130. Operational states (also referred to herein as “operational modes”) may include modes of operation used for various types of interaction between user 126 and system 100. The operational states may be detected and acted upon by system 100 as further discussed herein.

As shown in step 202 of process 200, system 100 and/or logic device 114, may indicate an initiation of an interactive session with system 100. User 126 may begin initiation of system 100 by using an initiation gesture. In various embodiments, logic device 114 may be configured to detect an initiation gesture, and thus receive an initiation command, of user 126. For instance, logic device 114 may be configured to receive an initiation command from user 126 that indicates the user desires to begin (e.g., initiate) an interaction (e.g., interactive session) with system 100. Logic device 114 may be configured to provide feedback in response to the initiation command. For instance, logic device 114 may be configured to indicate the initiation of the interactive session of system 100 after receiving a first gesture of a gesture sequence (also referred to herein as a “sequence of gestures”). For instance, user 126 may make a first gesture, such as a closed fist, to indicate the desire to begin the interactive session. In various embodiments, logic device 114 may be configured to indicate the initiation of the interactive session and provide feedback by updating at least a portion of the user interface. For example, display 102 may show an icon of a fist, indicating the receipt of the initiation command from user 126.

As shown in step 204 of process 200, system 100 and/or logic device 114 may confirm the initiation of the interactive session. In some embodiments, system 100 may confirm the initiation of the interactive session after receiving a second gesture of the gesture sequence. For instance, the second gesture may include a confirmation gesture by user 126. In one or more embodiments, logic device 114 may indicate receipt of the confirmation gesture by providing feedback by updating at least a portion of the user interface. For example, feedback in response to the confirmation gesture may include the flashing of an icon having a symbol representing the confirmation gesture on display 102.

As shown in step 206 of process 200, system 100 may continue the interactive session by tracking one or more faces and/or hands of one or more users, such as face 128 and/or hand 130 of user 126, and identifying gestures of hand 130. For instance, the interactive session may continue by user 126 selecting one or more selectable features 106 using a selection gesture. Logic device 114 may be configured to detect the selection gesture, and, in response to receiving a selection command associated with the selection gesture, allow user 126 to select a feature 106 of the user interface during the interactive session in response. In one or more embodiments, system 100 may be configured to receive selection gestures from user 126 by tracking intentional and unintentional movements and/or positions of user 126 (e.g., hand 130 and/or face 128), as discussed further below in this disclosure.

As shown in step 208 of process 200, system 100 and/or logic device 114 may be configured to conclude the interactive session in response to detecting a final gesture of user 126. For instance, the final gesture may include an end gesture by user 126 that is associated with an end command, which instructs logic device 114 to conclude the current interactive session. In various embodiments, once interactive session has ended, system 100 will not respond to any gestures by user 126 other than the initiation gesture as described in step 202, which will then begin process 200 again with a new interactive session.

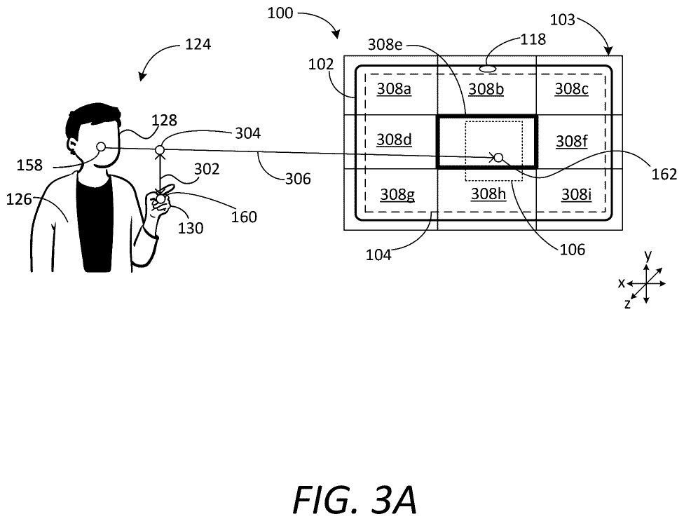

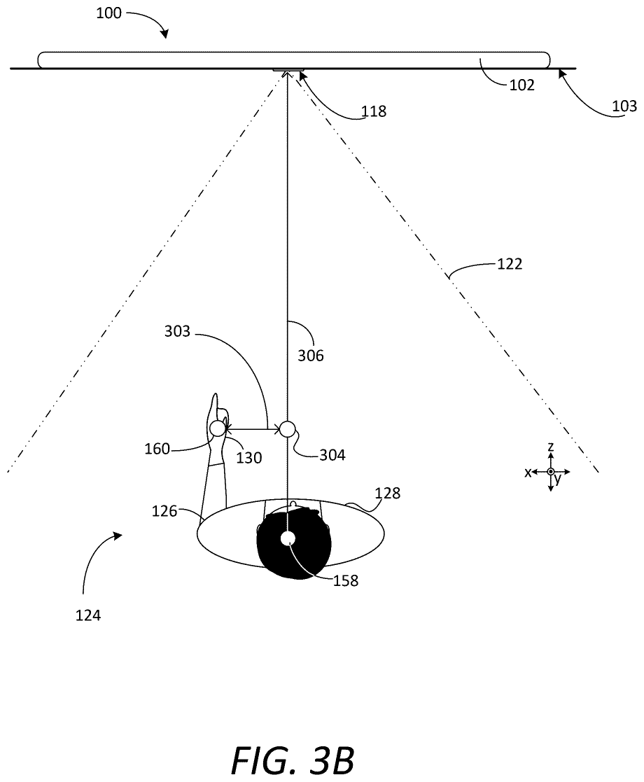

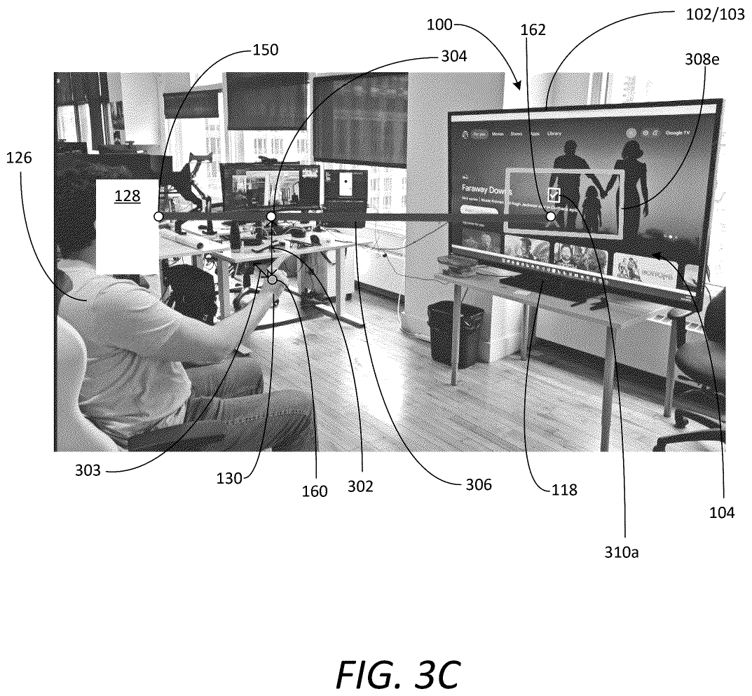

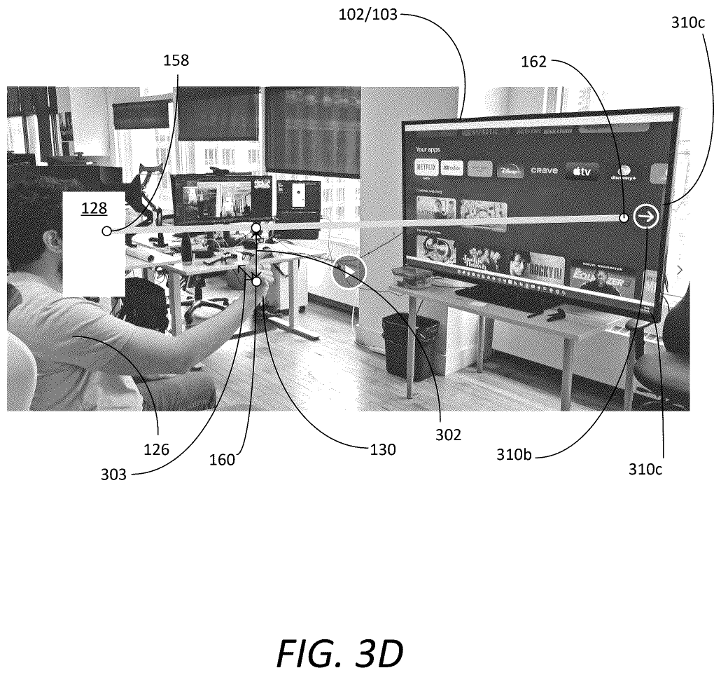

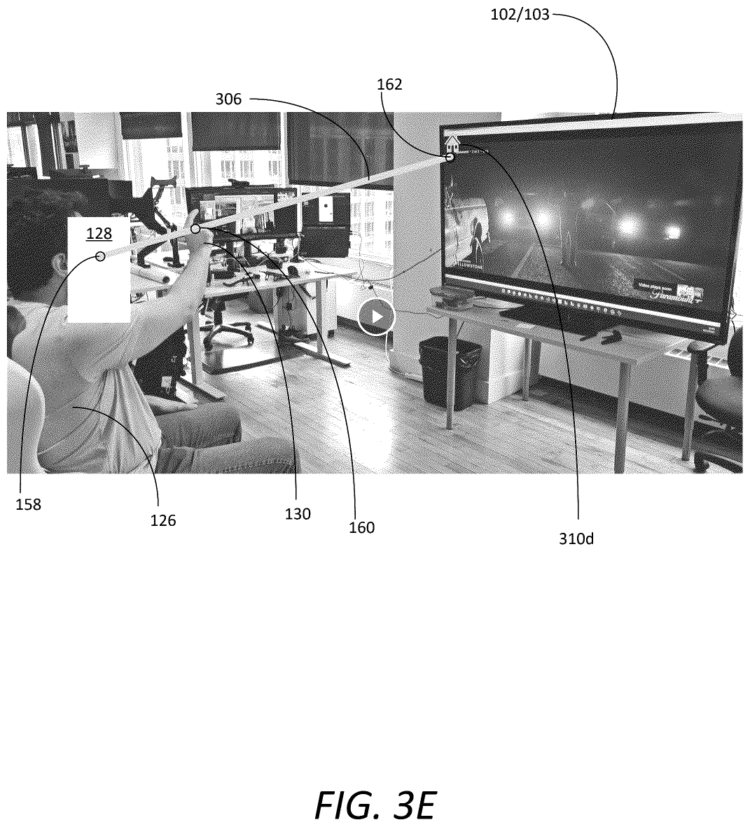

Additionally and/or alternatively, system 100 and/or logic device 114 may be configured to end the interactive session based on inactivity of user 126 or if user 126 cannot be tracked for more than a predetermined amount of time (e.g., within a specific time threshold). For example, and without limitation, if hand 130 and/or face 128 of user 126 cannot be detected after one minute, then system 100 may end the interactive session. Now referring to FIGS. 3A-3E, operation of system 100 is shown in accordance with an embodiment of this disclosure. In one or more embodiments, logic device 114 is configured to receive an image (e.g., frame) of scene 124. As shown in FIG. 3A, imaging device 118 may capture the image of scene 124 with user 126 positioned therein and transmit the image to logic device 114 using, for example, communication component 116. In some embodiments, scene 124 may include a plurality of users and/or persons and a background.

In some embodiments, logic device 114 may be configured to alter and/or adjust the image received from imaging device 118. Altering and/or adjusting the image may reduce computing power needed for subsequent processing steps of the image and/or may improve image quality for detection or tracking purposes. For instance, logic device 114 may be configured to convert a resolution, a frame rate, a bit depth, a color fidelity, a dynamic range, a compression state, and/or another image characteristic of the raw imagery to a lower resolution, a lower frame rate, a lower bit depth, a lower color fidelity, a narrower dynamic range, a relatively lossy compressed state, and/or the like to the raw image. In other instances, logic device 114 may be configured to rotate, skew, translate, and/or otherwise transform raw image. In other instances, logic device 114 may adjust and/or later the image by providing color, white-balance, and/or exposure correction to the raw image. For example, logic device 114 may be configured to provide histogram equalization that may include determining three characteristic distribution values corresponding to the distribution of greyscale pixel values in the image, and then, applying a gain function (e.g., a constant, linear, B-spline, and/or other gain function), and adjust the greyscale pixel value distribution of the image such that the three characteristic distribution values are equal to preselected target distribution values.

In one or more embodiments, logic device 114 may be configured to detect one or more hands 130 and face 128 of user 126 in the image. In some embodiments, logic device 114 may be configured to detect one or more hands of one or more users in the image. In various embodiments, logic device 114 may use face detection ANN 136 and hand detection ANN 132 to detect face 128 and hands 130, respectively.

In one or more embodiments, logic device 114 is configured to assign a first point 158 to face 128 and a second point 160 to hand 130 in a three-dimensional space. In some non-limiting embodiments, first and second point 158 and 160 may each include points in a three-dimensional Cartesian space that may be defined by orthogonal axes (e.g., x-axis, y-axis, and z-axis). As understood by one of ordinary skill in the art, though assigning points are described as being assigned to a singular user, points 158 and 160 may be assigned to any number of users within scene 124. Additionally, points 160 may be assigned to each hand of each user 126 or only one hand (e.g., a dominant hand) of each user 126. In various embodiments, first point 158 may be assigned to a center of face 128, and second point 160 may be assigned to a center of hand 130. In other embodiments, second point 160 may be assigned to a wrist of hand 130.

In some embodiments, assigning first point 158 and second point 160 includes estimating a length of face 128 and a length of hand 130, respectively, in a first dimension (e.g., y-axis) of the three-dimensional space, and calculating distances of face 128 and hand 130 from a plane 103 in a second dimension (e.g., z-axis) of the three-dimensional space using the estimated lengths. The lengths of face 128 and hand 130 may be estimated by logic device 114 by comparing face 128 and hand 130 to an exemplary face and hand, respectively, of a database (e.g., a database of memory 108). Exemplary face and hand may include a standardize face and had representative of a population average. In other embodiments, exemplary face and had may include a previously stored hand or face of user 126.

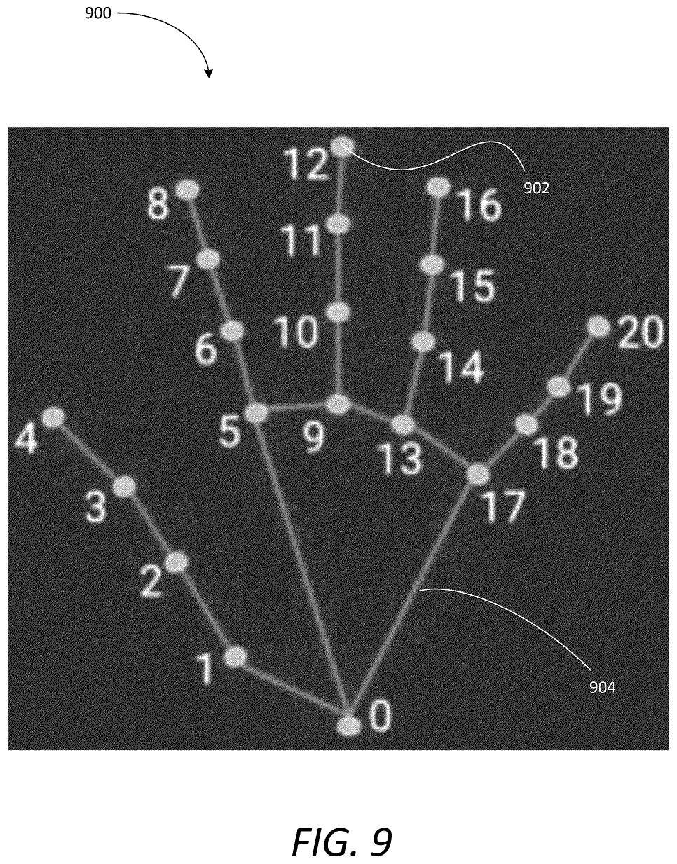

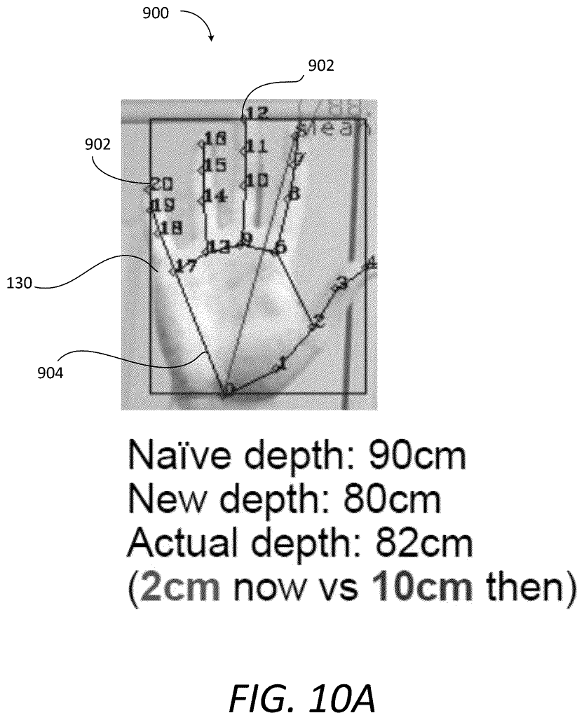

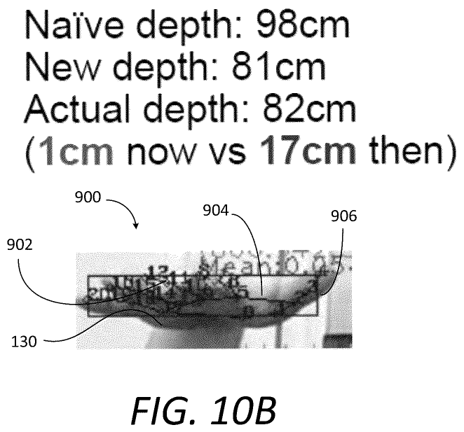

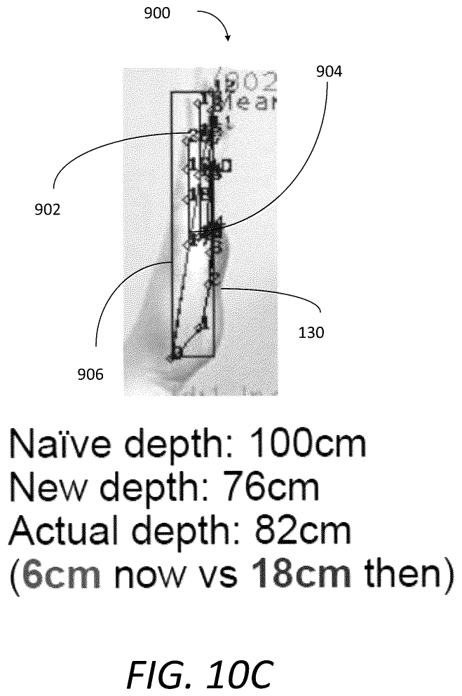

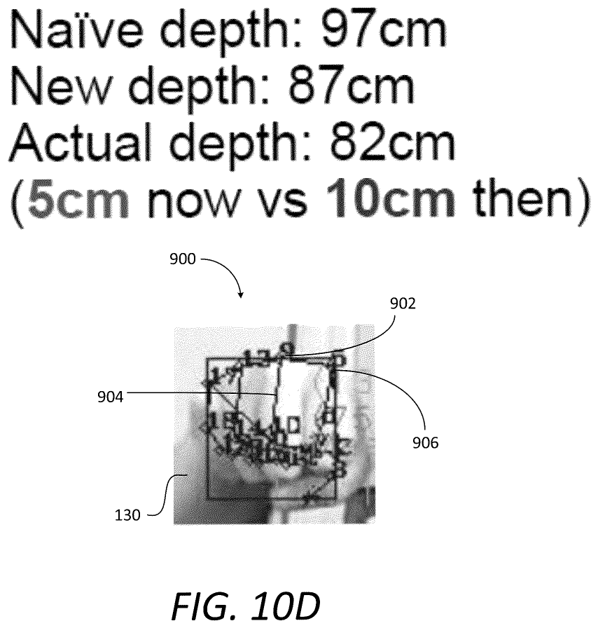

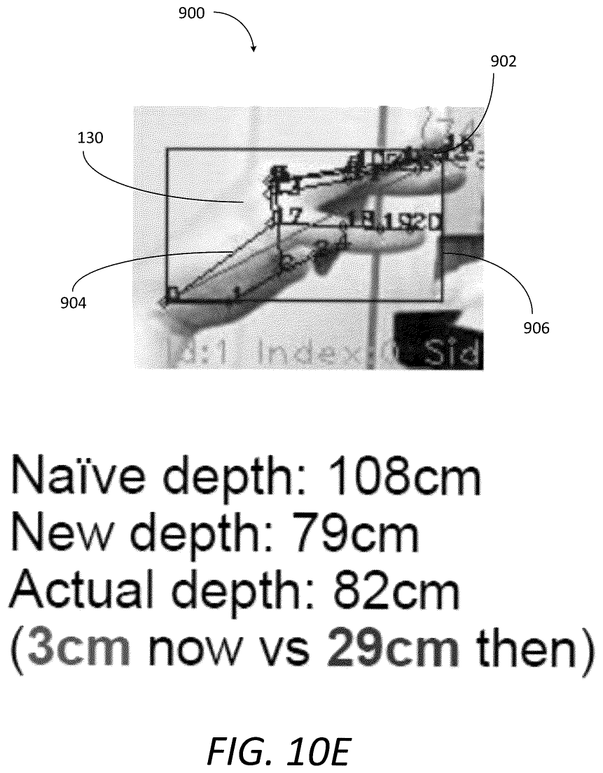

In other embodiments, logic device 114 may be configured to estimate the length of hand 130 by assigning a plurality of landmarks to corresponding locations on hand 130, generating a plurality of connecting lines between pairs of the landmarks, calculating a length of each connecting line, and selecting one of the calculated lengths, as discussed further at least in FIG. 9 and FIGS. 10A-10E. In one or more embodiments, the selecting one of the calculated lengths includes selecting the one of the calculated lengths closest to a previously selected length associated with a previous image.

In other embodiments, assigning second point 160 includes generating a three-dimensional rendering of scene 124 and hand 130 based on one or more system parameters of imaging device 118 associated with plane 103. Logic device 114 may then be configured to calculate a distance of hand 130 from plane 103 in the three-dimensional space by matching the three-dimensional rendering of hand 130 to a three-dimensional model from a perspective associated with imaging device 118.

In one or more embodiments, plane 103 may be associated with the user interface of system 100. Plane 103 may be associated with various components of system 100, such as with imaging device 118 or display 102. For example, plane 103 may include a defined area substantially aligned with imaging device 118 (e.g., plane 103 may correspond to a focal plane of imaging device 118; alternatively, plane 103 may be aligned with physical hardware of imaging device 118; other alignments are also contemplated). A distance x between hand 130 and plane 103 may be substantially equal to a distance x′ between hand 130 and imaging device 118. Additionally and/or alternatively, plane 103 may be associated with display 102, which may provide a user interface. For instance, distance x between hand 130 and plane 103 may be substantially equal to a distance x′ between hand 130 and display 102. Plane 103 may be overlayed on a surface of one or more displays of system 100. For example, logic device 114 may be configured to superimpose the user interface over other content (e.g., content 104). In one or more embodiments, plane 103 may be aligned with a planar surface of display 102 of system 100. In some embodiments, display 102 may not be planar and thus a point on plane 103 may be aligned with a point on the surface of display 102.

In various embodiments, the user interface may be defined by plane 103. The user interface, and thus plane 103, may include one or more portions (e.g., portions 308a-i). Portions 308a-i may include distinct regions (e.g., areas) of at least a portion of the under interface and/or plane 103. In one or more embodiments, a portion of the user interface is one of a plurality of discrete portions 308a-i of the user interface, each associated with one or more user selectable features 106. Portions 308a-i may include defined sectors of a two-dimensional plane (e.g., plane 103). In various embodiments, when plane 103 is aligned with display 102, areas of display 102 may be defined by portions 308a-i. For example, content 104, such as one or more selectable features 106 shown on display 102, may be located in one or more portions 308a-i of plane 103. In one or more embodiments, plane 103 may extend beyond display 102 to allow for tolerance in the operation of system 100, as shown in FIG. 3A. Thus, a terminal point 162 of vector 306 may be located outside of a border (e.g., perimeter) defined by display 102 while still intersecting plane 103.

As understood by one of ordinary skill in the art, though portions 308a-i are shown as rectangles arranged in a grid, portions 308a-I may be any shape or size as appropriate for the operation of system 100. For instance, portion 308a-i may be the same size and shape as selectable feature 106 (e.g., a portion may outline a selectable feature). In other instances, each portion may include a region that completely encompasses selectable feature 106. In other instances, selectable feature 106 may be partially disposed with one or more portions 308a-i.

In one or more embodiments, logic device 114 may be configured to calculate a vector 306 extending from a first point 158 through a second point 160 to terminal point 162 on plane 103 (e.g., display 102) in the three-dimensional space. In some embodiments, second point 160 may include a hand point (e.g., marker or anchor) located in the center of hand 130 or at a wrist of hand 130. In other embodiments, second point 160 exhibits an offset relative to a position of hand 130 in one or more dimensions in the three-dimensional space. For example, second point 160 may include an intersection point 304, where intersection point 304 having a vertical offset 302 (shown in FIG. 3A) and/or a horizontal offset 303 (shown in FIG. 3B) based on a current position of hand 130 relative to face 128 in the image and/or plane 103. The offset of second point 160 may allow for terminal point 162 or a visual representation of terminal point 162 from being obstructed by hand 130 of user 126 during operation of system 100. For instance, the offset may be used to prevent a cursor on display 102 from being positioned behind the user's hand during operation of system 100.

In one or more embodiments, logic device 114 may be configured to update portion 308a-i of the user interface associated with terminal point 162. In various embodiments, updating user interface may include providing a cursor at or proximal to terminal point 162 (e.g., showing a cursor that indicates the location of terminal point 162 in real time on display 102), illuminating one or more light emitting diodes (LEDs), providing an audible sound (e.g., a verbal announcement or an audible cue, such as a ping or chime sound), identifying a selectable user interface feature 106, change visual representations of content 104 on display 104 (e.g., changing from a first menu to a second menu), and so on. In various embodiments, updates to the user interface may include, but are not limited to, changes in transparency, color, image size, and/or text size of content 104 and/or selectable features 106. In other embodiments, updates to the user interface may include a transformation of content 104 and/or selectable features 106, a transition between one or more contents 104 and/or selectable features 106, movement (e.g., displacement) of content 104 and/or selectable features 106, audible sounds, visual pulses radiating from a location of the terminal point on plane 103, a glowing perimeter of display 102, and the like.

For example, as shown in FIG. 3C, selectable feature 106 may be located within portion 308e of the user interface and may be selected using, for example, a selection gesture when terminal point 162 is located within portion 308e (e.g., within the boundary of portion 308e) of the user interface. For example, and without limitation, user 126 may position hand 130 such that terminal point 162 is located within portion 308e and pinch their fingers together to select a selectable feature 106 disposed at least partially within the boundary of portion 308e. In one or more embodiments, the updating of the user interface may include generating an icon, such as icon 310a, to visually notify user 126 that a command has been received and/or responded to by system 100.

In another example, as shown in FIG. 3D, selectable feature 106 may include an icon 310b that appears when terminal point 162 is in a specific portion, such as portion 308f, and/or location of the user interface and when user 126 is making a selection gesture (e.g., pointing at plane 103 and/or user interface using a pointer finger of hand 130). The updating of the user interface may further include a real time alteration in a visual representation of content 104 (e.g., a change in color of one or more selectable features 106 or content 104 and/or a highlight around a perimeter of one or more selectable features 106 or content 104). For example, coloration change 310c of display 102 may provide a visual cue and/or indication to user 126 that terminal point 162 is currently located within a specific portion of the user interface.

In another example, as shown in FIG. 3E, selectable feature 106 may include an icon 310d that appears when terminal point 162 is in a specific portion, such as portion 308a, of the user interface and when user 126 is making a selection gesture (e.g., pointing using pointer finger).

In some aspects, specific commands, and corresponding gestures, may be performed without the requirement of terminal point 162 being in a particular location (e.g., portion 308a-i) on the user interface. For instance, user 126 may stop an interactive session with system 100 based on an end gesture alone (e.g., the position of user's hand 130 relative to face 128 and/or the user interface is irrelevant).

In some embodiments, an on-screen action (e.g., an update to a portion of the user interface) may be generated in response to a gesture of hand 130 and the current location of terminal point 162 on display 102. In some embodiments, logic device 114 may be configured to detect a gesture depicted by hand 130 in the image so that the updating of user interface is performed in response to the detected gesture alone. As previously discussed in this disclosure, in one or more embodiments, the gesture of hand 130 may be detected by an ANN, such as depth ANN 138, trained using the training data of gesture database 110. In one or more embodiments, the gesture may include an initiation gesture by user 126 to begin the interactive session. In other embodiments, the gesture may include a confirmation gesture by user 126 to continue the interactive session. In other embodiments, the gesture may include the selection gesture by user 126 to select a feature 106 of the user interface associated with the portion 308a-i of the user interface, which terminal point 162 is positioned within during the interactive session. In other embodiments, the gesture may include the end gesture by user 126 to end the interactive session, as previously discussed in FIG. 2.

In one or more embodiments, creating one or more gestures may include the use of two hands of user 126. For instance, hand 130 may include a first hand and the gesture may include a first gesture, and logic device 114 may be configured to detect a second hand of user 126 in the image and a second gesture depicted by the second hand in the image. Logic device 114 may then be configured to update the user interface in response to the second detected gesture. In some embodiments, logic device 114 may be configured to update the user interface in response to the second detected gesture in a manner different from the updating performed in response to the first detected gesture. In a non-limiting embodiment, user 126 may bring their first hand and second hand together to reduce a size of selectable feature 106. In one or more embodiments, the first gesture and the second gesture may be different from each other. In other embodiments, the first gesture and the second gesture may be substantially the same.

In one or more embodiments, logic device 114 may be configured to repeat any of the processes and/or steps described herein for a plurality of additional images to detect a plurality of different gestures by the user over time. In one or more embodiments, logic device 114 may be configured to perform any of the processes and/or steps described herein to detect multiple users within scene 124. For instance, logic device 114 may be configured to repeat the detecting process for additional hands and faces of additional users and track the hands and the faces of the user and the additional users over a plurality of additional images.

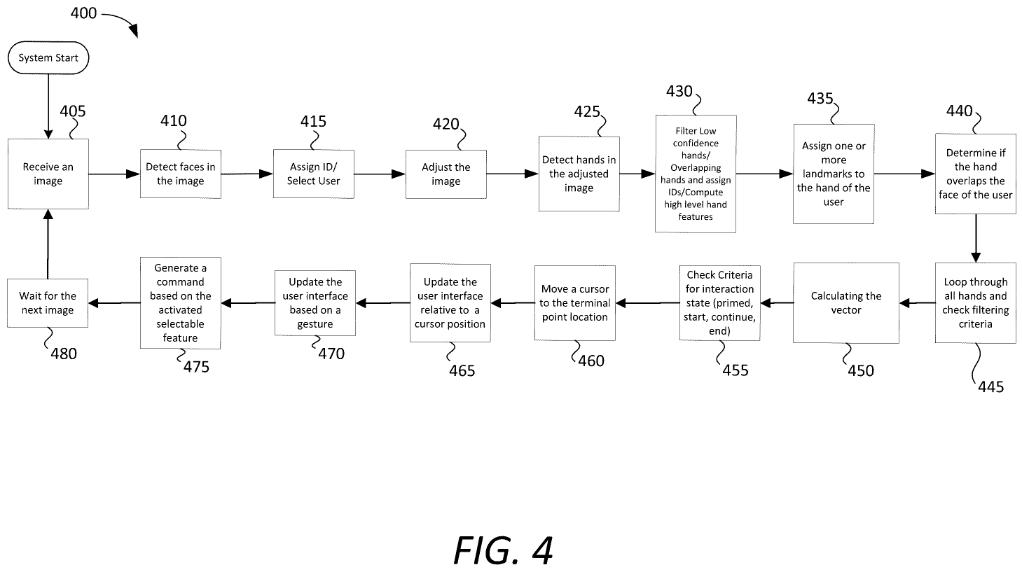

FIGS. 4-7 identify various flowcharts/processes as further discussed herein. It will be appreciated that any of the various steps performed therein may be performed by logic device 114, including one or more of the ANNs and/or other logic 112 provided by logic device 114. Now referring to FIG. 4, a flow chart for a process 400 of operating system 100 is illustrated in accordance with an embodiment of this disclosure. In one or more embodiments, system 100 is configured to allow user 126 to operate a menu on display 102 (e.g., a screen) remotely by, for example, pointing at display 102 and performing a gesture to activate selectable feature 106 (e.g., user interface elements), as previously described in FIGS. 1A-3E. In some embodiments, system 100 may use imaging module 118, such as a single RGB or IR camera, to capture an image of user 126 (e.g., film the user). As shown in step 405, process 400 may include starting system 100, by for example, providing power to system 100 and receiving, by logic device 114, the image (e.g., a first image) captured by imaging device 118. Receiving, by logic device 114, the image from imaging module 118 may be consistent with any similar processes and/or methods described herein.

As shown in step 410, process 400 may include detecting, by logic device 114, one or more faces 128 in the image. Detecting the one or more faces may be consistent with detecting, by logic device 114, one or more faces 128 of one or more users 126 as described throughout this disclosure. In one or more embodiments, detecting face 128 may include using face detection ANN 136. Face detection ANN 136 may be configured to identify face 128 and/or identify an expression and/or orientation of face 128 for use in determining gestures or commands, as described in further detail herein below. For instance, ANN 136 may determine face 128 of user 126 is looking away from system 100.

As shown in step 415, process 400 may include assigning, by logic device 114, a first point 158 to face 128 of user 126. For example, first point 158 may include a tag indicating the presence of user 126 within the image, and, more specifically, a presence and current location of face 128 of user 126 within the image. First point 158 may include an identifier, such as an identification (ID) of user 126, where the identifier is associated with an identify of the user. Assigning first point 158 may include selecting a detected person (e.g., face 128) of user 126 (e.g., an individual that system 100 may receive commands from). Logic device 114 may be configured to select user 126 from various persons in scene 124 based on face data from face database (e.g., historical data) or based on a command from user 126 (e.g., an initiation and confirmation command). In one or more embodiments, assigning a tag may include assigning a first point 158 to face 128. In some embodiments, assigning a tag may include providing an identifier associated with user 126 using face recognition. In some embodiments, face recognition may be used so only an authorized user may interact with system 100. For example, face database may include a user identification (e.g., identifier) and an associated level of authorization of the user, where a level of authorization may include, for example, no authorization to interact with system 100, limited authorization to interact with system 100 (e.g., the user may only interact with system 100 if a supervisor and/or guardian, such as a user with complete authorization, is present within scene 124 or at least initiates system 100), and complete authorization to interact with system 100 (e.g., the user has unlimited access and/or control of system 100).

In some embodiments, ANNs are trained to reliably assign points, such as first and second points, using training data sets of training images and associated training points that are first de-optimized to mimic common unfavorable image capture circumstances and/or characteristics, such as, for example, noise, low lighting, and the like within scene 124. The resulting trained ANN, such as face detection ANN 136 or hand detection ANN 132 of FIGS. 1A-1B, may be used for assigning points, such as first and second points, respectively, for use in a variety of applications in the control of system 100 using gestures, including, but not limited to gesture determination, depth determination, user presence-based initiation of an interactive session, user presence-based end of an interactive session, authentication, user interface updates, and/or other operational control of system 100, components thereof, and/or applications executed by such system 100. In one or more embodiments, unfavorable conditions may also be overcome by the use of one or more particular components, such as the use of infrared imaging devices in low light environments.

As shown in step 420, process 400 may include adjusting, by logic device 114, the image. Adjusting the image may include any processes and/or steps described herein for adjusting and/or altering the image. For example, adjusting the image may include performing one or more transformations to raw image data of the image, as described in FIGS. 1A-3E. This can include scaling, cropping, resizing, adjusting colors, altering a resolution, and the like of the image. In other exemplary embodiments, to reduce fatigue, strain, or occlusions, the intersection with the screen (e.g., terminal point 162) may be modified in various ways based on the distance and position of user 126 and plane 103 (e.g., display 102). This can include scaling, offsetting, and/or rotating a raw terminal point. The head and hand position of user 126 that is used by logic device 114 may also be modified in the same way for the same reason.

As shown in step 425, process 400 may include detecting, by logic device 114, hands in the image. For example, logic device 114 may be configured to detect hands 130 in the adjusted image from step 420. Detecting hands 130 may be consistent with any processes and/or steps of detecting hands 130 described herein. For example, logic device 114 may be configured to detect hand 130 using hand detection ANN 132 shown in FIG. 1A.

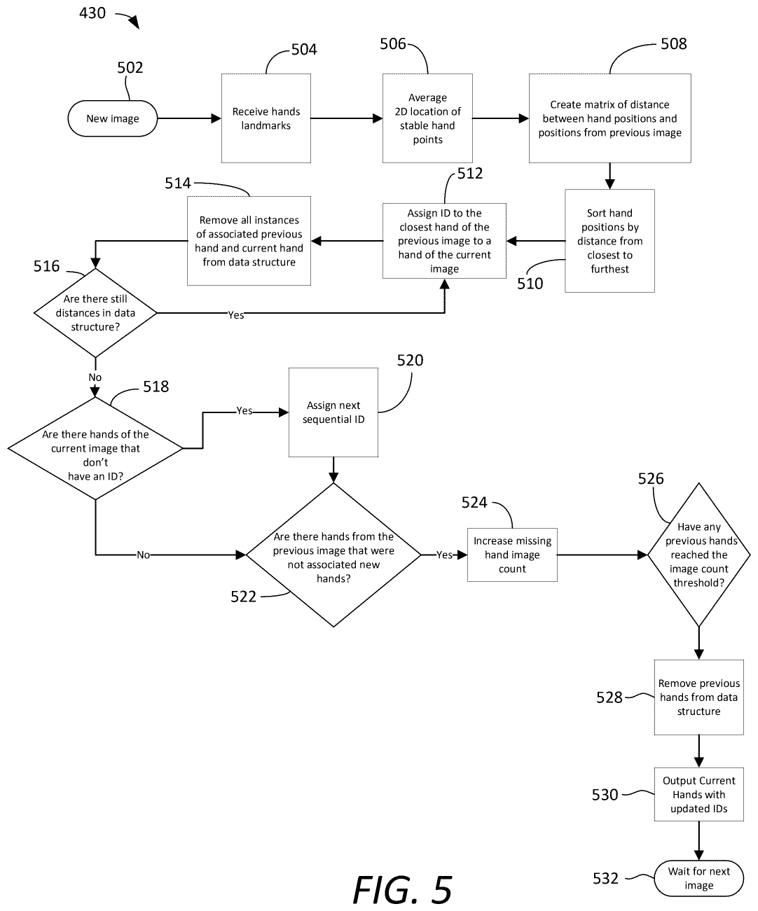

As shown in step 430, process 400 may include processing, by logic device 114, the image after one or more faces 128 and hands 130 have at least been detected in the image. For instance, processing the image may include filtering low confidence hands. In another instance, processing the image may include detecting overlapping hands. In another instance, processing the image may include assigning and/or computing IDs (e.g., assigning one or more second points 160 to one or more corresponding hands 130). In another instance, processing the image may include computing high-level hand features, such as landmarks. Processing the image in step 430 may be consistent with processing the image as described further in FIG. 5 below.

In various embodiments, occlusions of the face by hand 130 of user 126 may occur. To avoid occlusions (e.g., obstructions) from interfering with the operation of system 100, logic device 114 (e.g., hand tracking ANN 134 of logic device 114) may be configured to detect an occlusion based on the image. For example, logic device 114 may be configured to detect when an occlusion has or may happen and modify face data by using previously valid face data from a previous image (e.g., the last image to have a clear visual of face 128). Modifying face data of the image may prevent another person's face from being selected in an image instead of the occluded user's face 128. Furthermore, once face 128 reappears in a subsequent image, tracking of face 128 may resume.

In various embodiments, to support different operational states (shown in FIG. 2), it is important to determine if hands from a first image are the same as hands in a second image. To determine if the hands tracked from one image to another are the same hands, a layer of logic is added on top of the raw neural network used (e.g., hand tracking ANN 134) since the image, and corresponding image data, may be often noisy and intermittent. In one or more embodiments, hand tracking ANN 134 may assign second points and/or landmarks, respectively, in each image that include unique corresponding IDs for each detected hand. Once hand is seen for the first time in an image, a sequential unique ID may be assigned to the hand. As long as the hand is visible, the same ID may remain associated with the hand in subsequent images.

In some embodiments, if more than one hand is visible, the ID may be associated with a hand based on the proximity of the hand from one image to another image and possibly handedness (e.g., determination of a dominant hand of the user). When hand 130 is no longer visible in one image of a plurality of images, logic device 114 may be configured to detect, using hand tracking ANN 134, a new hand near the last know position of hand 130 and to assign the new hand the same ID as the previous lost hand (e.g., the hand that was no longer visible in the previous image). Such a process allows for continuous tracking of hands 130 when hands 130 are obstructed and/or when hands 130 momentarily go out of frame (e.g., are not within FOV 122, shown in FIG. 1A).

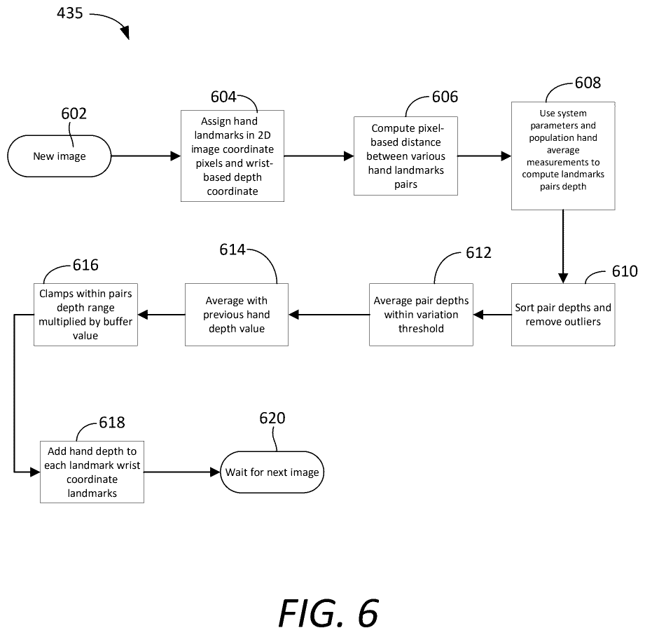

As shown in step 435, process 400 may include assigning, by logic device 114, landmarks to one or more hands 130 of user 126, as described further in FIG. 6. The process of assigning landmarks to hands may be consistent with assigning landmarks to hands as described throughout this disclosure. For instance, landmarks may be assigned to hand 130 using depth ANN 138.

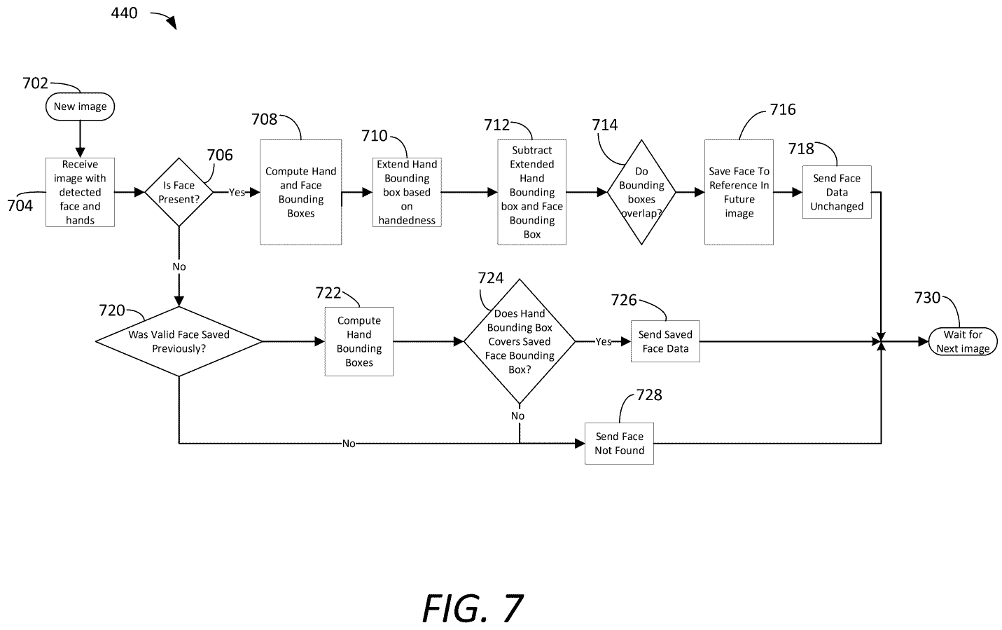

As shown in step 440, process 400 may include determining, by logic device 114, if hand 130 overlaps face 128. If hand 130 overlaps face 128, then logic device 114 may be configured to replace face data of one image with face data of a previous image, as described further in FIG. 7.

As shown in step 445, process 400 may include looping, by logic device 114, through all hands within the image and checking filtering criteria. In one or more embodiments, the previous steps of process 400 may be repeated with any number of hands within the image, as understood by one or ordinary skill in the art.

As shown in step 450, process 400 may include calculating, by logic device 114, vector 306, which may extend from first point 158 through second point 160 to terminal point 162 on plane 103 in the three-dimensional space. As previously described in this disclosure, calculating vector 306 may include deeming an offset, where second point 160 exhibits an offset relative to a position of hand 130 in one or more dimensions in the three-dimensional space (shown in FIGS. 3A-3E). In some embodiments, second point 160 may be located at the position of hand 130 (e.g., at a wrist of hand 130). In other embodiments, second point 160 may be located at the offset, such as, for example, at intersection point 304. In one or more embodiments, scaling of plane 103 may be used to determine vector 306. For instance, vector may be calculated by logic device 114 based on system parameters (e.g., a size of display 102, a distance of hand 120 from plane 103, and the like), as previously discussed in FIG. 1A. In one or more embodiments, the offset of second point may be based on a distance between user 126 and plane 103 (e.g., imaging module 118) and/or display 102 and/or interactions.

As shown in step 455, process 400 may include checking, by logic device 114, criteria for the operational state of an interactive session (e.g., primed, start, continue, and/or end). In one or more embodiments, checking the criteria for the operational state of the interactive session may be consistent with the interactive sessions described in FIGS. 2 and 8.

As shown in step 460, process 400 may include moving, by logic device 114, a cursor based on a location of terminal point 162 on plane 103 and/or display 102.

As shown in step 465, process 400 may include updating the user interface based on the location of the cursor on plane 103 and/or display 102, as previously described in FIGS. 1A-3E.

As shown in step 470, process 400 may include updating, by logic device 114, the user interface based on at least a gesture of hand 130. For example, a gesture may include pinching fingers together, waving, a thumbs up position, a thumbs down position, pointing, and so on, as previously described in FIGS. 1A-3E.

As shown in step 475, process 400 may include generating a command based on the activated selectable feature 106. Selectable feature 106 may be activated by terminal point 162 being located on selectable feature 106 and/or being located within the same portion 308a-i of the user interface that selectable feature 106 is located within, as previously described in FIGS. 1A-3E.

As shown in step 480, process 400 may include waiting, by logic device 114, to receive the next image (e.g., a second image and/or a subsequent image to the first image). Once the next image has been received by logic device 114, then process 400 may be iteratively repeated with the next image.

Now referring to FIG. 5, a flow chart of process 430 of FIG. 4 for assigning identifiers using system 100 is illustrated in accordance with an embodiment of this disclosure. Any of the steps of process 430 may be executed by logic device 114 and corresponding ANNs, such as hand tracking ANN 134. As shown in step 502, process 430 may include receiving, by logic device 114, the image (e.g., the first image), which may be consistent with the step of receiving the image as described in FIG. 4.

As shown in step 504, process 430 may include assigning landmarks, such as second point 160 and/or landmarks 902 of FIGS. 9 and 10A-10E, to one or more hands 130.

As shown in step 506, process 430 may include averaging, by logic device 114, a two-dimensional (2D) location of one or more second points 160 (e.g., stable points) for one or more corresponding hands 130 of user 126. For instance, as previously discussed, logic device 114 may be configured to estimate lengths of face 128 and hand 130 in a first dimension of the three-dimensional space and calculate distances of face 128 and/or hand 130 from plane 103 and/or display 102 in a second dimension of the three-dimensional space, using the estimated lengths to assign first point 158 and second point 160. The landmarks that are considered stable are the landmarks that are the least likely to move with respect to each other. Thus, placing second point on wrist and knuckles is often useful compared to fingertips and joints.

In some embodiments, a position of hand 130 in three-dimensional space may include using system parameters of imaging device 118 and using average human hand size measurements (e.g., information from a database) to estimate a depth (e.g., z-axis) of hand 130 from 2D data and 2.5D data provided by one or more ANNs (e.g., depth ANN 138). In one or more embodiments, 2.5D data refers to three-dimensional data (e.g., 3D hand data) with a frame of reference including a wrist of hand 130. A statistical approach to compare each possible measurement of hand 130 is used to obtain hand data that is as precise and constant as possible. Noisy and erroneous data may make the system unusable, but by knowing the position of plane 103 (and/or display 102) and face 128 and hand 130 of user 126 with respect to imaging device 118, it is possible to determine the intersection of vector 306 (e.g., terminal point 162) with plane 103. Terminal point 162 may then be implemented as the primary interaction modality with the user interface on plane 103 and/or display 102, for example, akin to a mouse cursor or a finger on a touchscreen.

As shown in step 508, process 430 may include creating a matrix that includes a distance between a position of hand 130 in the current image and positions of hand 130 from one or more previous images. In one or more embodiments, second points 160 (e.g., stable landmarks) of hand 130 from a plurality of images may be compared to create the matrix. In one or more embodiments, the image of scene 124 may include a first image and a subsequent second image. In one or more embodiments, a data structure may include the matrix, which may then be stored in memory 108.

As shown in step 510, process 430 may include sorting, by logic device 114, the images of hand 130 from one or more images based on distance, such as a closest distance to a furthest distance relative to each other.

As shown in step 512, process 430 may include assigning, by logic device 114, second point 160 and an associated identifier (e.g., ID) to the hand of the current image that is closest to the position of the hand of the previous image. In various embodiments, the identifier may indicate a specific user, such as a current user or first user of a plurality of users. The identifier may track with second point within images of scene 124, so that logic device 114 may readily identify each user (e.g., that a user is the same image to image).

As shown in step 514, process 430 may include removing, by logic device 114, all instances of the associated previous hand from previous images and the current hand from the current image from the data structure.

As shown in step 516, process 430 may include determining, by logic device 114, if there are still distances in the data structure. If there are still distances in the data structure, then logic device 114 may be configured to repeat the steps of 512 and 514 and assign a second point of the closest hand to the current hand in the image.

As shown in step 518, if there are no remaining distances in the data structure after step 516, then process 430 may include determining, by logic device 114, if there are hands in the current image that have not been assigned corresponding second points 160 and/or identifiers.

As shown in step 520, if there are hands in the current image that have not been assigned a second point and/or identifiers, then process 430 may include assigning, by logic device 114, a next sequential second point and/or identifier.

As shown in step 522, if all hands in the current image have an assigned second point 160 and/or identifier, then process 430 may include determining, by logic device 114, if there are hands of a previous image that were not associated to the hands of the current image.

As shown in step 524, if there are hands from the previous image that were not associated with new hands of the current image, then process 430 may include increasing, by logic device 114, a missing hand image count.

As shown in step 526, process 430 may include determining, by logic device 114, if any hands of the previous image have reached an image count threshold, where the image count threshold includes a predetermined amount of hands from the previous image.

As shown in step 528, if previous hands have reached the image count threshold, then process 430 may include removing, by logic device 114, the previous hands from the data structure.

As shown in step 530, process 430 may include outputting hands 130 and associated second point 160 of the current image.

As shown in step 532, process 430 may include waiting, by logic device 114, for a next, subsequent image so that the process may be repeated if appropriate.

To support different operational states (e.g., interaction states), the tracking of one or more hands from image to image is important. To achieve this, a layer of logic is added on top of the raw neural network since the image data may often be noisy and intermittent. Gaps in hand tracking must be handled since they are frequent and can interrupt the interaction with the system. Landmarks provided by hand tracking ANN 134 for each image may be assigned unique points (e.g., IDs) to allow for identification of each detected hand. Once a hand is seen for the first time, a sequential unique ID may be assigned to the hand. As long as the hand is visible within the image, the same ID may be associated with the hand from one image (e.g., the first image) to the next image (e.g., the second image). If more than one hand is visible, the ID may be associated with the hand based on a proximity of the hand to imaging device 118 (e.g., plane 103) from image to image and/or by handedness of the user. When hand 130 is lost within an image, logic device 114 may allow for a predetermined duration of time for a new hand to be identified near the last know location of hand 130 within scene 124. In such a case, the new hand may be assigned the same ID as the previous lost hand 130. This allows for handling of any gaps in tracking by the neural network (e.g., hand tracking ANN 134) or a hand going out of frame and back in.

Now referring to FIG. 6, a flow chart of an exemplary process 435 for assigning landmarks (e.g., landmarks 902 of FIG. 9) to hand 130 of user 126 is illustrated in accordance with an embodiment of this disclosure. Any of the steps of process 435 may be executed by logic device 114 and corresponding ANNs (e.g., depth ANN 138).

As shown in step 602, process 435 may include receiving, by logic device 114, the image (e.g., the first and/or current image), which may be consistent with receiving an image as described in previous FIGS. 1A-4.

As shown in step 604, process 435 may include assigning, by logic device 114, landmarks 902 in two-dimensional coordinate pixels and a wrist-based depth coordinate (e.g., second point 160 and/or landmark 902). Logic device 114 may be configured to identify a depth and/or gesture of hand 130 by determining a hand depth estimation (also referred to in this disclosure as “hand depth estimate”). For instance, assigning landmarks 902 may include assigning landmarks 902 to one or more locations on hand 130 of the image based on an average hand standard, as previously mentioned, and/or second point 160, which may be positioned at a wrist of hand 130 and/or at the center of hand 130.

As shown in step 606, process 435 may include computing, by logic device 114, pixel-based distances (e.g., connecting lines 904) between two or more of the landmarks (e.g., pairs of landmarks). In various embodiments, determining the hand depth estimate may include computing and/or generating a plurality of connecting lines 904, where each connecting line 904 is defined by a pair of landmarks of a plurality of landmarks 902.

As shown in step 608, process 435 may include using, by logic device 114, system parameters (e.g., camera parameters) and/or population hand average measurements to calculate depths of connecting lines 904 of landmark pairs 902. In various embodiments, logic device 114 may be configured to determine an initial distance (e.g., initial depth) of each connecting line of the plurality of connecting lines 904 based on the first image, and determine a second distance (e.g., second depth) of each connecting line of the plurality of connecting lines 904 based on the second image. Logic device 114 may then be configured to compare the initial distance of each connecting line to a corresponding second distance of each connecting line. Logic device 114 may determine a minimum distance based on the comparisons where the minimum distance includes a length of a connecting line that has the minimum difference in length between an initial distance and second distance (e.g., the smallest difference in distance of the plurality of differences in distances).

As shown in step 610, process 435 may include sorting, by logic device 114, depths of pairs of landmarks 902. In various embodiments, sorting depths of pairs of landmarks 902 may include removing outliers.

As shown in step 612, process 435 may include averaging, by logic device 114, depths of pairs of landmarks within a predetermined variation threshold.

As shown in step 614, process 435 may include averaging the depths of pairs of landmarks with previous depths of pairs of landmarks (e.g., previous hand depth value).

As shown in step 616, process 435 may include multiplying, by logic device 114, clamps within the range of depths of pairs by a buffer value.

As shown in step 618, process 435 may include adding, by logic device 114, a depth to each landmark wrist coordinate landmarks.

As shown in step 620, process 435 may include waiting, by logic device 114, for the next image.

Now referring to FIG. 7, a flow chart of a process 440 for determining overlap using system 100 is shown in accordance with an embodiment of this disclosure. Occlusions of face 128 by the user's hand 130 may be inevitable during the operation of system 100. Thus, specific logic to make system 100 robust to such events may be provided. For example, logic device 114 may be configured to detect when an occlusion might happen, modify the face data associated with face 128 by using the previously valid face data from a previous image instead of the occluded or missing face data, preventing another person's face in scene 124 from being selected as the user instead of the occluded user's face 128. This process allows for continuous tracking of the user's face and/or resuming tracking of the user's face once the occlusion is no longer occurring. The steps of process 440 may be executed by logic device 114 and corresponding ANNs (e.g., hand tracking ANN 134 and/or a face tracking ANN).

As shown in step 702, process 440 may include receiving, by logic device 114, the image (e.g., the first image). As shown in step 704, process 440 may include receiving the image, which may include detected face 128 and hand 130 within a scene 124.

As shown in step 706, process 440 may include determining, by logic device 114, if face 128 of user 128 is within the current image.

As shown in step 708, if face 128 is detected, process 440 may include providing, by logic device 114, bounding boxes for face 128 and hand 130. In various embodiments, the bounding box may be extended to include at least a portion of the forearm of user 126, which may also obscure face 128 when using system 100.

As shown in step 710, process 440 may include extending, by logic device 114, the bounding box for hand 130 based on a determined handedness of user 126. For instance, logic device 114 may determine that a right hand of user 126 is the dominant hand that user 126 will use to make one or more gestures with.

As shown in step 712, process 440 may include subtracting, by logic device 114, the extended bounding box of hand 130 from the face bounding box. For instance, any portion of an area defined by hand bounding box may be subtracted from the face bounding box if the portion overlaps at least a portion of the face bounding box.

As shown in step 714, process 440 may include determining, by logic device 114, if the face bounding box and the hand bounding box overlap based on the subtraction of step 712.

As shown in step 716, process 440 may include storing (e.g., saving), by logic device 114, face 128 as a reference. For example, face 128 (e.g., face data) may be stored in memory 108 and/or databases for future use (e.g., for use in step 720 during process 440 of a subsequent image). For example, and without limitation, if a face is not detected in a subsequent image (e.g., second image), then logic device 114 may be configured to recall face data from the last image that face 128 was present in for use in the processing of the subsequent image.

As shown in step 718, process 440 may include providing, by logic device 114, the unchanged face data of the image. For instance, sending the unchanged and/or unprocessed face data may include providing the unchanged face data for the next step in process 400.

As shown in step 720, if in step 720 face is not found to be present, process 440 may include determining, by logic device 114, if face 128 was saved from a previous image. In various embodiments, face 128 (e.g., face data) may be saved in memory 108 and/or databases (e.g., such as a face database).

As shown in step 722, if valid face data was previously stored, then process 440 may include calculating, by logic device 114, hand bounding boxes, as described in step 708, using the recalled face data.

As shown in step 724, process 440 may include determining, by logic device 114, if the hand bounding box of hand 130 covers (e.g., overlaps) the face bounding box, which was calculated using the stored face data.

As shown in step 726, process 440 may include sending (e.g., transmitting), by logic device 114, the stored face data.

As shown in step 728, if face data was not saved from a previous image, then process 440 may include generating, by logic device 114, an alert that face 128 and/or face data was not found.

As shown in step 730, process 440 may include waiting, by logic device 114, to receive a subsequent image (e.g., second image).

Now referring to FIG. 8, a flow chart of a process 455 for checking criteria using system 100 in accordance with an embodiment of this disclosure. Process 455 may be consistent with process 200 of FIG. 2. As shown in step 802, process 455 may include starting system 100. Starting system 100 may include providing power to one or more components of system 100 or system 100 changing from a dormant mode (e.g., power “OFF” mode or rest mode) to an active mode (e.g., power “ON” mode or interactive session). Any of the steps of process 455 may be executed by logic device 114 and corresponding ANNs mentioned herein.

As shown in step 804, process 455 may include receiving, by logic device 114, face data associated with face 128 and augmented hand data associated with hand 130. Augmented hand data may include a data structure that contains hand data from the engine (e.g., logic device 114) and all the criteria (shown in FIG. 2) evaluated as well as the face and hand plane intersection data (e.g., terminal point 162) for each hand, imaging module coordinate system centroid of non-finger points and gesture (e.g., pinch state) information, such as a Boolean (Bool) state and float percentage. Process 455 is consistent with process 200 of FIG. 2. Receiving face and hand data may include receiving a processed or raw image of face 128 and hand 130.

As shown in step 806, process 455 may include determining, by logic device 114, if there is currently and interactive hand 130 of user 126 present.

As shown in step 808, if there is not currently an interactive hand, process 455 may include looping, by logic device 114, through all hands in the image, as previously discussed herein.

As shown in step 810, process 455 may include determining, by logic device 114, if hand 130 meets a start interaction criteria. In one or more embodiments, meeting a start interaction criteria (e.g., initiation criteria) may include detecting a gesture of hand 130 by user 126 that indicates that user 126 wishes to initiate an interactive session with system 100, as described previously in FIG. 2. System 100 may then provide feedback (e.g., update to the user interface) that indicates to user 126 that system 100 is tracking user 126 (e.g., tracking face 128 and hand 130 of user 126), as described further in FIG. 2 above.

As shown in step 812, process 455 may include determining, by logic device 114, if hand 130 meets a prime interaction criteria. In one or more embodiments, the prime interaction criteria may be retrieved from a database of memory 108. In various embodiments, prime interaction criteria may include a particular gesture, such as, for example, a fist gesture.

As shown in step 814, if hand 130 meets the prime interaction criteria of step 812, then process 455 may include displaying, by logic device 114, interaction primed feedback to user 126. In one or more embodiments, primed feedback may include an update of user interface to indicate to user 126 that system 100 has receive an initiation command. For example, and continuing the example in step 812, primed feedback may include an icon of a first located at the bottom of display 102. In another example, if system 100 includes a power plug, an LED on the power plug may repeatedly blink to alert user 126 that an initiation gesture was detect and system is being primed in response.

As shown in step 816, if hand 130 meets a start interaction criteria of step 810, then process 455 may include assigning, by logic device 114, hand 130 as the interactive hand (e.g., user hand). An interactive hand may include the hand that the user will predominately use to make gestures for operating system 100. Interactive hand may include the dominant hand of user 126. In some embodiments, system 100 may only assign one hand (e.g., the first hand) as the interactive hand. In other embodiments, system 100 may assign both hands (e.g., the first hand and the second hand) as the interactive hand, as previously discussed herein regarding gestures made using two hands.

As shown in step 818, if hand 130 meets the prime interaction criteria of step 812, process 455 may include determining, by logic device 114, if the primed feedback is display.

As shown in step 820, if the primed feedback is displayed, then process 455 may include hiding, by logic device 114, the interaction prime feedback user interface.

As shown in step 822, if there is currently an interactive hand, process 455 may include determining, by logic device 114, if an interaction end criteria is met. In one or more embodiments, user 126 may confirm that they want to end (e.g., conclude) an interactive session with system 100. For instance, determining if the interaction end criteria is met may include detecting an end gesture by user 126 to end the interactive session of system 100, as described in FIG. 2.

As shown in step 824, if the interaction end criteria is met, process 455 may include setting, by logic device 114, an interactive hand to empty.

As shown in step 826, if the interaction end criteria is not met, then process 455 may include continuing, by logic device 114, the interactive session. In one or more embodiments, logic device 114 may be configured to determine if a continue interaction criteria is met. Continue interaction criteria may include detecting the presence of user 126 and/or receiving commands from user 126 within a predetermined amount of time as described in FIG. 2.

As shown in step 828, if the continue interaction has not been met, then process 455 may include determining, by logic device 114, if a predetermined threshold for time has been reached. For example, if user 126 does not interact with system 100 (e.g., is no longer present in scene 124 and/or does not provide any commands to system 100) over a predetermined duration of time, then the predetermined threshold has been met.

As shown in step 830, if the continue interaction has been met, then process 455 may include updating, by logic device 114, hand data (e.g., interactive hand data) from the image, which may be used in step 804 for subsequent images.

Now referring to FIG. 9, landmarks 902 assigned to hand 130 of user 126 is shown in accordance with an embodiment of this disclosure. In one or more embodiments, logic device 114 may be configured to estimate the length of hand 130 in order to determine a gesture of hand 130. Estimating length of hand 130 includes assigning a plurality of landmarks 902 to corresponding location on hand 130. Estimating length of hand 130 may further include generating a plurality of connecting lines 904 between pairs of landmarks 902. Estimating length of hand 130 may further include calculating a length of each connecting line 904. Estimating length of hand 130 may further include selecting one of the calculated lengths.

For instance, in a non-limiting exemplary embodiment, the image of scene 124 may include a first frame and a subsequent second frame. Estimating the length of hand 130 may include generating a plurality of connecting lines 904, where each connecting line 904 is defined by two landmarks of the plurality of landmarks 902 (e.g., a pair of landmarks); determining an initial length of each connecting line of the plurality of connecting lines 904 based on the first frame; determining a second length of each connecting line of the plurality of depth lines 904 based on the second frame; comparing the initial length of each connecting line 904 to a corresponding second length of each connecting line 904; and determining a minimum difference of one of the depth lines based on the comparisons, where the minimum difference includes the smallest value between an initial length and a second length. The minimum difference may then be used by logic device 114 to estimate the depth of hand 130. Thus, logic device 114 is configured to use the estimated length of a frame that is closest to a previous estimated length of a previous frame to provide an accurate estimation of hand depth.

Now referring to FIGS. 10A-10E, various hand depth estimates are shown in accordance with an embodiment of this disclosure. By comparing the relative position of the hand landmarks with each other, logic device 114 may determine a specific gesture to perform actions at or around the terminal point on the display. As shown in FIG. 10A, hand 130 is in a front open gesture (e.g., outstretch fingers with the palm of the hand facing imaging device 118), where all connecting lines 904 and landmarks 902 are visible in image 900. By comparing image 900 to a previous image, the connecting line 904 closest in length to the corresponding connecting line in the previous image is used to accurately estimate a depth of hand 130. FIG. 10B shows hand 130 making a prone open gesture (e.g., palm facing downward toward the floor). FIG. 10C shows hand 130 making a side open gesture (e.g., palm of the hand facing to a side). FIG. 10D shows hand 130 making a fist gesture (e.g., fingers curled).

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
receiving an image of a scene;
detecting a face and a hand of a user in the image;
assigning first and second points to the face and the hand, respectively, in a three dimensional space;
calculating a vector extending from the first point through the second point to a terminal point on a plane in the three dimensional space; and
updating a portion of a user interface associated with the terminal point.

2. The method of claim 1, wherein the plane is associated with an imaging device configured to provide the image.

3. The method of claim 1, wherein the plane is associated with a display providing the user interface.

4. The method of claim 3, wherein the terminal point is outside a border defined by the display.

5. The method of claim 1, wherein the second point exhibits an offset relative to a position of the hand in one or more dimensions in the three dimensional space.

6. The method of claim 1, further comprising:
detecting a gesture depicted by the hand in the image; and
wherein the updating is performed in response to the detected gesture.

7. The method of claim 6, wherein the gesture is detected by an artificial neural network (ANN) trained using a gesture database.

8. The method of claim 6, wherein the gesture is one or more of:
an initiation gesture by the user to begin an interactive session;
a confirmation gesture by the user to continue the interactive session;
a selection gesture by the user to select a feature of the user interface associated with the portion of the user interface associated with the terminal point during the interactive session; and/or
an end gesture by the user to end the interactive session.

9. The method of claim 6, wherein the hand is a first hand and the gesture is a first gesture, the method further comprising:
detecting a second hand of the user in the image;
detecting a second gesture depicted by the second hand in the image;
wherein the first and second gestures are different from each other; and
further updating the user interface in response to the second detected gesture in a manner different from the updating performed in response to the first detected gesture.

10. The method of claim 1, wherein the assigning the first and second points comprises:
estimating lengths of the face and the hand in a first dimension of the three dimensional space; and
calculating distances of the face and the hand from the plane in a second dimension of the three dimensional space using the estimated lengths.

11. The method of claim 10, wherein the estimating the length of the face comprises comparing the face to a database.

12. The method of claim 10, wherein the estimating the length of the hand comprises:
assigning a plurality of landmarks to corresponding locations on the hand;
generating a plurality of connecting lines between pairs of the landmarks;
calculating a length of each connecting line; and
selecting one of the calculated lengths, wherein the selecting comprises selecting the one of the calculated lengths closest to a previously selected length associated with a previous image.

13. The method of claim 1, wherein the assigning the second point comprises:
generating a three dimensional rendering of the scene and the hand based on one or more parameters of an imaging device associated with the plane and configured to provide the image; and
calculating a distance of the hand from the plane in the three dimensional space by matching the three dimensional rendering of the hand to a three dimensional model from a perspective associated with the imaging device.

14. The method of claim 1, wherein the updating comprises one or more of:
providing a cursor at the terminal point;
illuminating a light emitting diode (LED);
providing an audible sound; and/or
identifying a selectable user interface feature.

15. The method of claim 1, wherein the portion of the user interface is one of a plurality of discrete portions of the user interface each associated with user selectable features.

16. The method of claim 1, further comprising superimposing the user interface over other content.

17. The method of claim 1, further comprising repeating the method for a plurality of additional images to detect a plurality of different gestures by the user over time.

18. The method of claim 1, further comprising:
repeating the detecting for additional hands and faces of additional users; and
tracking the hands and the faces of the user and the additional users over a plurality of additional images.

19. The method of claim 1, wherein the detecting and the assigning are performed by one or more artificial neural networks (ANNs) operating on a logic device.

20. A system comprising:
an imaging device configured to provide an image of a scene; and
a logic device configured to:
receive the image,
detect a face and a hand of a user in the image,
assign first and second points to the face and hand, respectively, in a three dimensional space,
calculate a vector extending from the first point through the second point to a terminal point on a plane in the three dimensional space, and
update a portion of a user interface associated with the terminal point.
